(19) United States
(12) Patent Application Publication
(10) Pub. No.: US 2024/0019054 A1
(43) Pub. Date: Jan. 18, 2024

(54) FIXING CAP ASSEMBLY AND PIPE FITTING INCLUDING THE SAME

(71) Applicants: PPI CO., LTD., Hwaseong-si, Gyeonggi-do (KR); PPI AMERICA INC., Chicago, IL (US)

(72) Inventors: Jong-Tae LEE, Seoul (KR); Hye-Jung LEE, Chicago, IL (US); Ki-Woong HWANG, Yangju-si (KR)

(73) Assignees: PPI CO., LTD., Hwaseong-si, Gyeonggi-do (KR); PPI AMERICA INC., Chicago, IL (US)

(21) Appl. No.: 18/038,876

(22) PCT Filed: Mar. 19, 2021
(86) PCT No.: PCT/KR2021/003460

§ 371 Date: May 25, 2023

(30) Foreign Application Priority Data
Nov. 27, 2020 (KR) 10-2020-0163004

(51) Int. Cl. F16L 19/10; F16L 19/12

(52) U.S. Cl. CPC F16L 19/106; F16L 19/12

(57) ABSTRACT

The present disclosure relates to a fixing cap assembly and a pipe fitting including same. The fixing cap assembly according to an embodiment of The present disclosure comprises: a fixing cap fastened to a connection portion of a main body, to which at least one pipe is connected, and fixing the main body and the pipe to each other; a washer which is positioned inside the fixing cap and compresses a sealing member (120), interposed between the main body and the pipe, as the fixing cap is fastened, and of which the diameter contracts and is restored in the radial direction; and a coupling member including a plurality of tooth-shaped protrusions which protrude radially from the inner circumferential surface of the washer toward the outer circumferential surface of the pipe and press the outer circumferential surface of the pipe as the washer contracts, thereby fixing the pipe.

### FIELD

Embodiments of the present disclosure relate to a fixing cap assembly for pipe connection and a pipe fitting including the same, and more specifically, to a pipe fitting for connecting a plurality of pipes to each other, a fixing cap assembly used for connecting a pipe to a main body of equipment such as a house inlet or a small manhole requiring pipe connection, and a pipe fitting including the same.

### DESCRIPTION OF RELATED ART

A pipe is mainly used for transport of fluid (gas or liquid) or powder. A passage of the fluid defined by the pipe is referred to as a ‘pipe conduit’. In addition, installation of the pipe conduit in consideration of a flow rate, physical property values, a frictional resistance, and the like of the fluid is referred to as piping.

In general, during piping work, one or more pipes, preferably, multiple pipes, are connected to each other. In this regard, a cap for pipe connection (hereinafter, referred to as a fixing cap assembly) is mainly used.

For example, the fixing cap assembly may be used not only for a pipe fitting for connecting a plurality of pipes to each other, but also for equipment such as a house inlet or a small manhole.

The pipe fitting is mainly used when connecting the plurality of pipes to each other to change a direction of the pipe conduit or branch the pipe conduit.

In addition, the house inlet or the small manhole may have various shapes and structures depending on a purpose. Wastewater collected in one place by the house inlet or the small manhole must be discharged to the outside via at least one branched pipe. In this regard, the fixing cap assembly for the pipe connection may be used.

In a conventional scheme, for the pipe connection, one end of the pipe was inserted into a main body and then a cap was fastened thereto to restrain a connection portion of the pipe. However, according to such a conventional scheme, there was a disadvantage in that it was inappropriate to withstand a pressure under a condition of a high water pressure equal to or higher than a set level, and there was a disadvantage in that it was difficult to secure watertightness.

Recently, a pipe connection scheme has been introduced, in which a sealing member is installed between the main body (or a pipe fitting main body) and the pipe, and the cap directly pressurizes the sealing member to create a seal when fastened.

However, there are disadvantages in that the watertightness is deteriorated under the condition of high water pressure of the set level, a structure for strongly coupling the pipes to each other is insufficient, and work convenience is poor due to complexity of the pipe connection work.

### DISCLOSURE

### Technical Purposes

A purpose of the present disclosure is to provide a fixing cap assembly that simplifies a connection work between a target main body (e.g., a pipe fitting, a house inlet, a small manhole, and the like) to which a pipe is to be connected and the pipe, while maintaining the connection of the pipe with a great coupling force.

Another purpose of the present disclosure is to provide a pipe fitting that connects a plurality of pipes to each other using the fixing cap assembly.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

### Technical Solutions

According to one aspect of the present disclosure, a fixing cap assembly for connecting a pipe to a pipe connection portion of a pipe fitting or a main body to which at least one pipe is connected, for example, a house inlet or a small manhole, may be provided.

A fixing cap assembly according to an embodiment of the present disclosure includes: a fixing cap fastened to a connection portion of a main body to be connected with at least one pipe, wherein the fixing cap fixes the main body and the pipe to each other; a washer located inside the fixing cap, wherein the washer compresses a sealing member interposed between the main body and the pipe as the fixing cap is fastened to the connection portion, wherein the washer is contracted and restored in a radial direction; and a coupling member including a plurality of toothed protrusions, wherein the plurality of toothed protrusions protrude in the radial direction from an inner circumferential surface of the washer toward an outer circumferential surface of the pipe, wherein the plurality of toothed protrusions fix the pipe by pressurizing the outer circumferential surface of the pipe as the washer is contracted.

The coupling member according to an embodiment of the present disclosure may include a plurality of toothed protrusions inserted into and fixed to the inner circumferential surface of the washer in a circumferential direction at a predetermined spacing. As an example, the toothed protrusions divided into 3 to 10 pieces may be disposed around the inner circumferential surface of the washer in the circumferential direction, and may pressurize the outer circumferential surface of the pipe so as to fix the pipe when the washer contracts.

In addition, the coupling member according to another embodiment of the present disclosure may include a ring-shaped body and a plurality of toothed protrusions.

The ring-shaped body may be inserted into the inner circumferential surface of the washer and may be contracted and restored based on the washer. Respective ends on one side of the plurality of toothed protrusions may be connected to each other in a circumferential direction with predetermined spacing grooves therebetween inside the ring-shaped body, and respective ends on the other side of the plurality of toothed protrusions may protrude in a sawtooth shape toward the outer circumferential surface of the pipe.

In addition, the plurality of spacing grooves may be defined between the plurality of toothed protrusions so as to be spaced apart from each other at a certain distance.

In this regard, each of the plurality of spacing grooves may have a circular groove shape.

When each spacing groove has a circular groove shape, for example, a circular groove shape with a constant radius of curvature, when the ring-shaped body contracts in response to the contraction of the washer, a load may be evenly distributed without concentrating on a specific portion of the spacing grooves. As a result, even when the ring-shaped body made of a metal material is repeatedly contracted and restored, local deformation of the material may be prevented, and a durability life may be increased. Furthermore, improvement of contraction and restoration performance of the ring-shaped body may be expected.

In addition, the ring-shaped body may be inserted into a circular fitting groove defined in the inner circumferential surface of the washer. The ring-shaped body may be inserted into the circular fitting groove defined in the inner circumferential surface of the washer, and perform the act of being contracted or restored along with the washer in the radial direction in response to the contraction and the restoration of the washer. Accordingly, the plurality of toothed protrusions connected into the ring-shaped body may move in a direction pressurizing the outer circumferential surface of the pipe or releasing the pressurization, thereby fixing or releasing the pipe.

In addition, the coupling member may further include an elastic connection member for providing an elastic force required for the restoration when the ring-shaped body contracts.

Both ends of the elastic connection member may be connected to an opening where a partial circular arc section is disconnected in a ring shape of the ring-shaped body, and the elastic connection member may be made of an elastic material. As an example, the elastic material band having a shape and a length corresponding to those of the disconnected opening of the ring-shaped body may be used as the elastic connection member.

In addition, each toothed protrusion may have a sharp portion whose cross-section is reduced in a direction of protrusion thereof away from the ring-shaped body. As an example, the sharp portion may have a sharp sawtooth shape capable of being meshed with and fixing the outer circumferential surface of the pipe.

In addition, one surface of the sharp portion may be formed to have a curved surface bent in a direction opposite to a connection direction of the pipe. As one surface of the sharp portion has the curved surface bent in a round shape, and such curved surface is formed in a direction opposite to a connection direction of the pipe, interference between the pipe and the sharp portion is reduced when inserting the pipe, thereby facilitating the insertion of the pipe. In addition, after the connection between the sharp portion and the pipe is made, the pipe may be coupled in a direction opposite to a direction in which the pipe is separated, so that a greater coupling force may be secured.

In addition, the plurality of toothed protrusions may be provided in a form of multiple pieces separated from each other.

In addition, the washer may include: a first annular body located at a front relative to a fastening direction of the fixing cap, wherein the first annular body is contracted and restored in the radial direction, wherein the first annular body has a circular fitting groove defined therein; and a second annular body connected to a rear end of the first annular body relative to the fastening direction of the fixing cap, wherein the second annular body has a reduced diameter compared to a diameter of the first annular body, the first annular body may include a plurality of gaps cut in a straight line shape at a predetermined spacing along a circumferential direction, and a wedge-shaped protrusion protruding obliquely downward toward the fixing cap may be further disposed on an outer circumferential surface of the first annular body.

In addition, the fixing cap may include an annular cap body having a hollow for receiving the pipe inserted thereinto, the cap body may have an inner diameter greater than an outer diameter of the pipe to be connected, a plurality of circumferential protrusions protruding so as to be spaced apart from each other in a circumferential direction may be disposed on an outer circumferential surface of the cap body, and a female thread screwed to a male thread at each of both ends of the pipe fitting main body may be disposed on an inner circumferential surface of the cap body.

In addition, the main body may include: a pipe receiving portion formed in the connection portion of the main body to be connected with the pipe, wherein at least a portion of the pipe is inserted into the pipe receiving portion; a pipe support formed inside the pipe receiving portion and protruding to restrict an insertion length of the pipe; a male thread formed on an exterior of the pipe receiving portion and screwed to a female thread of the fixing cap; and a sealing member receiving portion formed stepwise inside the pipe receiving portion and accommodating the sealing member therein.

The washer may be formed such that a tip thereof enters the sealing member receiving portion when the fixing cap is fastened, and the sealing member may include at least one elastic ring elastically deformed such that a contact area between the main body and the pipe is expanded by pressurization of the tip of the washer in the sealing member receiving portion when the fixing cap is fastened.

According to another aspect of the present disclosure, a pipe fitting using a fixing cap assembly is provided.

A pipe fitting according to the embodiment of the present disclosure includes: a pipe fitting main body for connecting a plurality of pipes to each other; each sealing member inserted into each of both ends of the pipe fitting main body, wherein each sealing member creates a sealing between each end of the pipe fitting main body and each pipe; each fixing cap screwed to each end of the pipe fitting main body while surrounding a connection portion of each pipe; each washer located inside each fixing cap, wherein the washer compresses each sealing member located between the pipe fitting main body and each pipe as the fixing cap is fastened, wherein the washer is contracted and restored in a radial direction; and each coupling member including a plurality of toothed protrusions, wherein the plurality of toothed protrusions protrude in the radial direction from an inner circumferential surface of each washer toward an outer circumferential surface of each pipe, wherein the plurality of toothed protrusions pressurize and fix the outer circumferential surface of the pipe as the washer is contracted.

The pipe fitting main body may include a plurality of pipe receiving portions located at both ends in a length direction of the pipe fitting main body and receiving the plurality of pipes to be connected therein, respectively; and a connection portion connecting the plurality of pipe receiving portions to each other and having a reduced diameter compared to that of the plurality of pipe receiving portions, and a pipe support for restricting the insertion of each of the plurality of pipes to be connected may protrude in a direction reducing an inner diameter of the connection portion at a center in the length direction of the connection portion.

The washer may include: a first annular body located at a front relative to a fastening direction of the fixing cap, contracted and restored in a radial direction, and having a circular fitting groove defined therein; and a second annular body connected to a rear end of the first annular body relative to the fastening direction of the fixing cap and having a reduced diameter compared to that of the first annular body, the first annular body may include a plurality of gaps cut in a straight line shape at a predetermined spacing along a circumferential direction, and a wedge-shaped protrusion protruding obliquely downward in a direction opposite to the fastening direction of the fixing cap may be further disposed on an outer circumferential surface of the first annular body.

### Technical Effects

According to the embodiments of the present disclosure, as the pipe is connected with the great coupling force, the watertightness may be secured even with the high water pressure condition and the disengagement of the pipe may be prevented.

In addition, according to the embodiments of the present disclosure, the fitting groove may be defined in the inner circumferential surface of the washer, and the coupling member for the coupling of the pipe may be formed in the scheme of directly assembling the plurality of toothed protrusions formed in the shape of the separated pieces to the fitting groove or connecting the plurality of toothed protrusions in the integrated manner to the ring-shaped body that is inserted into the fitting groove.

Accordingly, according to the present disclosure, even with the relatively simple structure, the washer and the coupling member are not exposed to the outside of the fixing cap, so that the outer appearance may be excellent. Further, because the washer may contract and the coupling member may strongly pressurize the outer circumferential surface of the pipe by the simple fastening of the fixing cap, the strength of the pipe connection may be improved.

### BRIEF DESCRIPTION OF DRAWINGS

FIG. 1 is a perspective view showing a state in which a pipe is connected to a main body using a fixing cap assembly according to an embodiment of the present disclosure.

FIG. 2 is an exploded perspective view showing a state in which a pipe is connected to a main body using a fixing cap assembly according to an embodiment of the present disclosure.

FIG. 3 is a perspective view showing a fixing cap assembly according to an embodiment of the present disclosure in a first direction.

FIG. 4 is a perspective view showing a fixing cap assembly according to an embodiment of the present disclosure in a second direction.

FIG. 5 is a cross-sectional view of a fixing cap assembly according to an embodiment of the present disclosure.

FIG. 6 is a view showing coupling structure and shape between a washer and a coupling member among components of a fixing cap assembly according to an embodiment of the present disclosure.

FIG. 7 is a view showing an exemplary shape of a coupling member among components of a fixing cap assembly according to an embodiment of the present disclosure.

FIG. 8 is a view showing an exemplary shape of a coupling member among components of a fixing cap assembly according to another embodiment of the present disclosure.

FIG. 9 is a cross-sectional view showing a state before connecting a pipe to a main body using a fixing cap assembly according to an embodiment of the present disclosure.

FIG. 10 is a cross-sectional view showing a state after connecting a pipe to a main body using a fixing cap assembly.

FIGS. 11 and 12 are perspective views showing a pipe fitting connection structure including a fixing cap assembly according to an embodiment of the present disclosure.

### DETAILED DESCRIPTIONS

Hereinafter, with reference to the drawings, an embodiment of the present disclosure will be described in detail such that a person having ordinary knowledge in the technical field to which the present disclosure belongs may easily practice the same. The present disclosure may be implemented in many different forms and may not be limited to the embodiment described herein.

To clearly describe the present disclosure, portions irrelevant to the description are omitted, and the same reference numerals are given to the same or similar components throughout the present document. In addition, some embodiments of the present disclosure will be described in detail with reference to the drawings. In adding reference numerals to components of each drawing, the same components may have the same numerals as much as possible even if they are indicated in different drawings. In addition, in describing the present disclosure, when it is determined that a detailed description of a related known component or function may obscure the gist of the present disclosure, the detailed description may be omitted.

In describing the components of the present disclosure, terms such as first, second, A, B, (a), (b), and the like may be used. These terms are merely intended to distinguish the components from other components, and the terms do not limit the nature, order or sequence of the components. When a component is referred to as being “connected to” or “coupled to” another component, it should be understood that the component may be directly connected or coupled to another component or a third component may be “interposed” between the component and another component or the component may be “connected to” or “coupled to” another component via the third component.

In addition, in implementing the present disclosure, components may be described in a subdivided manner for convenience of description, but they may be implemented in a single apparatus or module, or a single component may also be implemented across multiple apparatuses or modules.

Fixing Cap Assembly

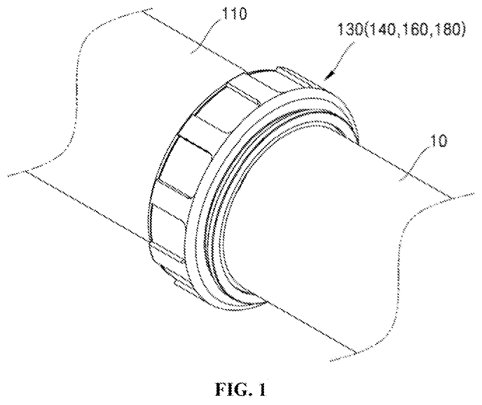

FIG. 1 shows a state in which a pipe 10 is connected to a main body (e.g., a house inlet, a small manhole, a pipe fitting, and the like) 110 using a fixing cap assembly according to an embodiment of the present disclosure.

Referring to FIG. 1, although not shown separately, the main body (e.g., the house inlet, the small manhole, the pipe fitting, and the like) 110 to which the pipe 10 is connected is located on one side and the pipe 10 is located on the other side.

A fixing cap assembly 130 is located between the main body 110 and the pipe 10, and the fixing cap assembly 130 serves to fasten the main body 110 and the pipe 10 to each other with a simple scheme.

Although the term ‘main body’ is used for the main body 110 for convenience of description, specific examples of the main body 110 may include various equipment to which the pipe 10 is connected, for example, an apparatus such as the house inlet or the small manhole.

In addition, the main body 110 may be the pipe fitting of various shapes that is connected between the plurality of pipes 10 to change or diverge a flow direction of fluid.

The fixing cap assembly 130 may connect the main body 110 and the pipe 10 to each other under a high water pressure condition. In addition, the fixing cap assembly 130 has excellent waterproof performance and fixes the connected pipe 10 with great coupling force, thereby preventing separation and disengagement of the pipe 10.

In addition, the fixing cap assembly 130 may reduce complicated preliminary work for connecting the pipe 10 to the main body 110. For example, troublesome work of having to fasten a fixing cap 140 while partially inserting the pipe 10 into the main body 110 or inserting a separate washer 160 into the fixing cap 140 before fastening may be eliminated.

As such, when the fixing cap assembly 130 according to one embodiment of the present disclosure is used, a pipe construction work for connecting the pipe 10 to the main body 110 may be easily and quickly performed by a worker.

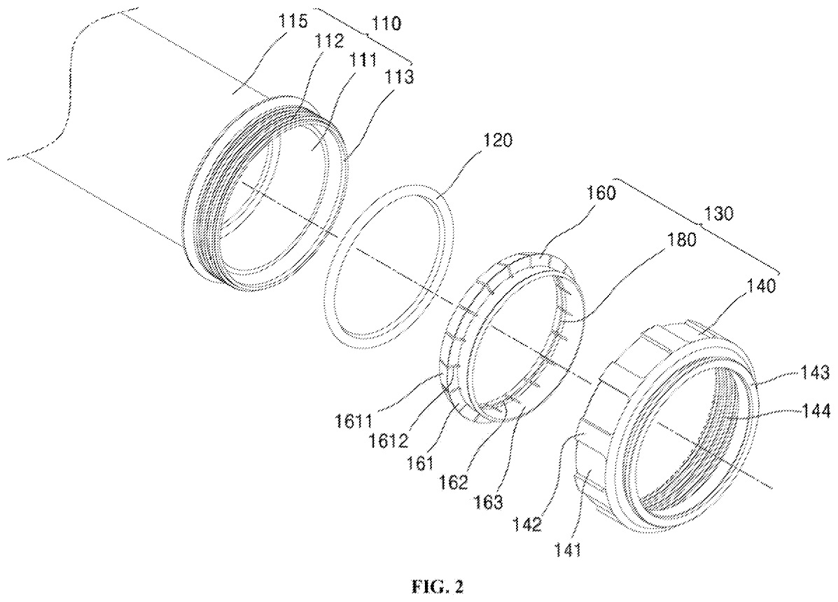

FIG. 2 is a view showing an exploded state before connecting a pipe to a main body using a fixing cap assembly according to an embodiment of the present disclosure.

Referring to FIG. 2, the fixing cap assembly 130 according to one embodiment of the present disclosure includes the fixing cap 140, the washer 160, and a coupling member 180.

The fixing cap 140 is fastened to a connection portion of the main body 110 to which the pipe 10 is connected, and serves to fix the main body 110 and the pipe 10 to each other.

Specifically, the fixing cap 140 is screwed to the connection portion of the main body 110 while surrounding the same.

As the fixing cap 140 is fastened to the main body 110 while fixing the main body 110 and the pipe 10 to each other, the fixing cap 140 maintains the connection between the main body 110 and the pipe 10 and prevents the separation and the disengagement of the pipe 10.

For example, the fixing cap 140 includes an annular cap body 141. The cap body 141 has an inner diameter greater than an outer diameter of the pipe 10 and has a size for allowing the pipe 10 to be inserted thereinto.

A circumferential protrusion 142 is disposed on an outer circumferential surface of the cap body 141. The circumferential protrusions 142 may protrude in a band shape while being spaced apart from each other in a circumferential direction on the outer circumferential surface of the cap body 141.

In addition, a female thread 144 is formed on an inner circumferential surface of the cap body 141. The female thread 144 of the cap body 141 is screwed to a male thread 112 formed on the main body 110.

In this regard, although not specifically shown, the main body 110 refers to the main body 110 of the various equipment to which at least one pipe 10 is connected, for example, the house inlet, the small manhole, the pipe fitting, and the like.

Referring to FIG. 2, the main body 110 includes a connection portion 115 to which the pipe 10 is connected, and a pipe receiving portion 111 defined in the connection portion 115 and into which at least a portion of the pipe 10 is inserted.

A pipe support 116 for restricting a length of the pipe 10 to be inserted may be further disposed inside the pipe receiving portion 111.

In addition, the male thread 112 is formed on an outer surface of the pipe receiving portion 111 and is screwed with the female thread 144 of the fixing cap 140 to enable fastening of the fixing cap 140.

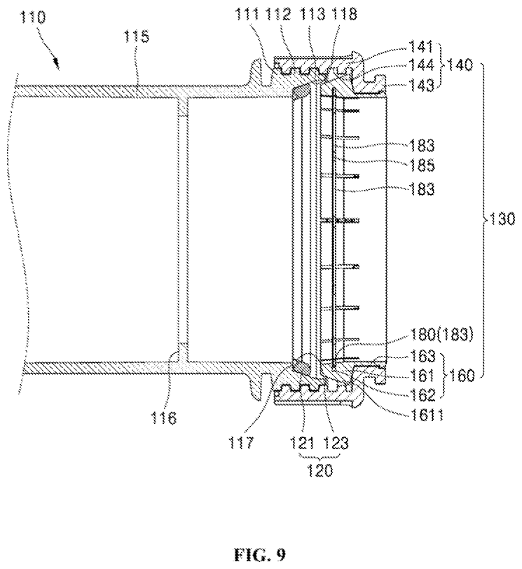

In one example, a sealing member receiving portion 117 (see FIG. 9) for receiving a sealing member 120 may be further defined inside the main body 110, more specifically, inside the pipe receiving portion 111.

The sealing member receiving portion 117 (see FIG. 9) is defined stepwise inside the pipe receiving portion 111 to allow the sealing member 120 to be interposed at a set location between the main body 110 and the pipe 10 and secure watertightness therebetween.

The sealing member 120 is formed to be strongly compressed on the sealing member receiving portion 117 (see FIG. 9) based on the fastening of the fixing cap 140 so as to secure the watertightness between the main body 110 and the pipe 10. To this end, the sealing member 120 may be made of a material capable of elastic contraction and restoration by an external force. For example, the sealing member 120 may be made of a rubber material for sealing.

The washer 160 is located inside the fixing cap 140, and compresses the sealing member 120 interposed between the main body 110 and the pipe 10 based on the fastening of the fixing cap 140 so as to secure the watertightness between the main body 110 and the pipe 10.

When the fixing cap 140 is fastened thereto, the sealing member 120 is strongly compressed between the main body 110 and the pipe 10 by pressurization of a tip of the washer 160, thereby sealing a gap. As a result, the sealing member 120 may exhibit the watertightness securing function even under the high water pressure condition.

In addition, the washer 160 is coupled into the fixing cap 140 in a ring shape. When the fixing cap 140 is fastened thereto, the washer 160 contracts in a radial direction, and when the fastening of the fixing cap 140 is released, the washer 160 is restored in the radial direction.

For example, the washer 160 includes a first annular body 161 that is located at a front relative to a fastening direction of the fixing cap 140 and is contracted and restored in the radial direction, and a second annular body 163 connected to a rear end of the first annular body 161. In addition, the first annular body 161 includes a plurality of gaps 1612 cut in a straight line shape at a set spacing along the circumferential direction, and a wedge-shaped protrusion 1611 protruding obliquely downward toward the fixing cap 140 is disposed on an outer circumferential surface of the first annular body 161.

The coupling member 180 includes a plurality of toothed protrusions 183 protruding in the radial direction from an inner circumferential surface of the washer 160 toward an outer circumferential surface of the pipe 10.

Specifically, the plurality of toothed protrusions 183 may have a sawtooth shape capable of strongly coupling the pipe 10 thereto by protruding, with a predetermined length, toward the outer circumferential surface of the pipe 10 that is inserted into the washer 160 when the washer 160 contracts.

As an example, the plurality of toothed protrusions 183 may be provided as 3 to 10 divided pieces. The toothed protrusions 183 may be arranged in the circumferential direction by being inserted into and fixed to the inner circumferential surface of the washer 160 one by one at a predetermined spacing. With such shape, the plurality of toothed protrusions 183 may strongly couple the pipe to the washer by being meshed with the outer circumferential surface of the pipe 10 when the washer 160 contracts.

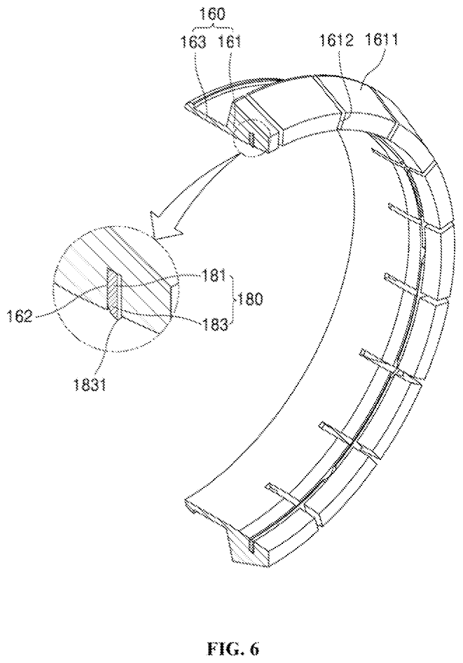

As another example, the coupling member 180 may have a structure including a ring-shaped body 181 and the plurality of toothed protrusions 183. This will be described in detail with reference to FIGS. 6 to 8.

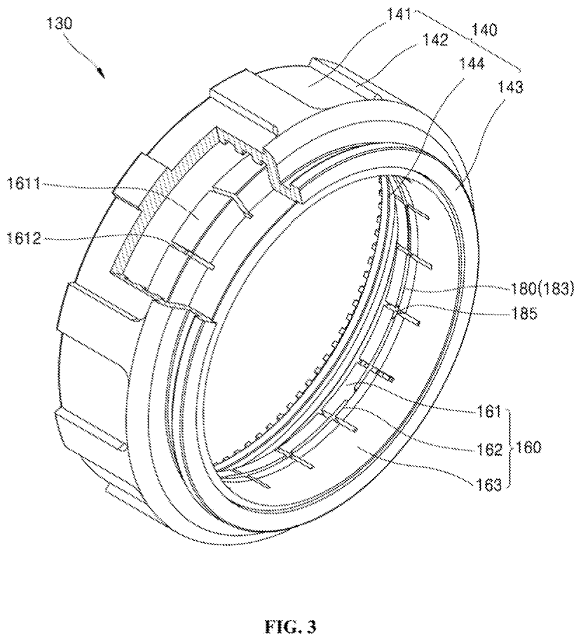

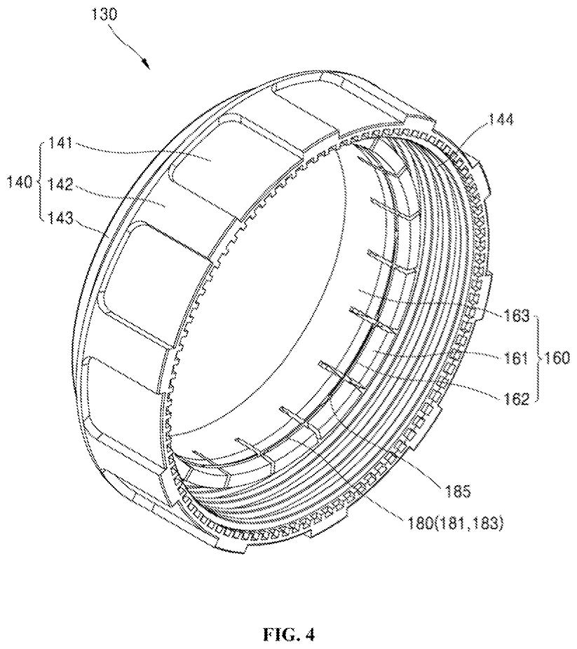

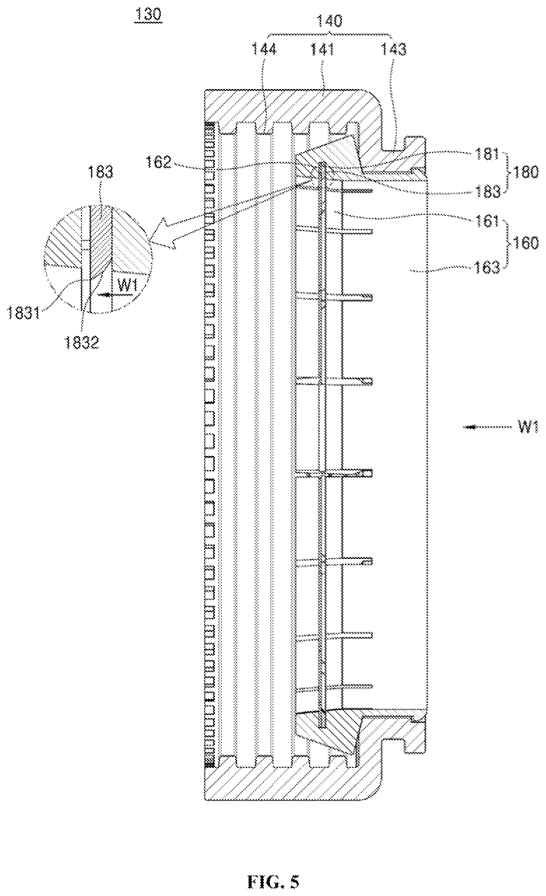

FIGS. 3 and 4 are perspective views showing a fixing cap assembly in first and second directions according to an embodiment of the present disclosure, respectively, FIG. 5 is a schematic cross-sectional view of a fixing cap assembly, and FIG. 6 shows coupling structure and shape between a washer and a coupling member.

The fixing cap 140 is screwed to the connection portion 115 of the main body 110 while surrounding a connection portion of the pipe 10, and fixes the main body 110 and the pipe 10 to each other.

The fixing cap 140 includes the annular cap body 141. The annular cap body 141 has the inner diameter greater than the outer diameter of the pipe 10, and the circumferential protrusion 142 is disposed on the outer circumferential surface of the cap body 141, so that the fixing cap may be screwed to the main body 110 in a scheme of rotating in a set direction.

For example, the circumferential protrusion 142 may protrude from the outer circumferential surface of the cap body 141 in a band shape. However, the circumferential protrusion 142 may not be necessarily limited to the illustrated shape, and may have various deformed shapes.

Further, the female thread 144 is disposed on the inner circumferential surface of the annular cap body 141, and the female thread 144 is screwed with the male thread 112 (see FIG. 2) of the main body 110 (see FIG. 2).

The fixing cap 140 further includes an inner diameter reducing portion 143.

The inner diameter reducing portion 143 is formed on the annular cap body 141 at a rear end in the fastening direction of the fixing cap 140. The inner diameter reducing portion 143 may be formed stepwise in a shape of reducing the diameter of the fixing cap 140 such that the annular cap body 141 has the inner diameter corresponding to the outer diameter of the pipe 10.

The inner diameter reducing portion 143 is formed to surround the pipe 10 to be connected to the main body 110 and supports the pipe 10, and at the same time, comes into contact with the second annular body 163 of the washer 160 to prevent the separation and the disengagement between the fixing cap 140 and the washer 160.

The washer 160 is coupled into the fixing cap 140. The washer 160 compresses the sealing member 120 between the main body 110 and the pipe 10 when the fixing cap 140 is fastened thereto.

For example, the washer 160 is formed such that the tip thereof enters the sealing member receiving portion 117 (see FIG. 9) when the fixing cap 140 is fastened thereto.

The washer 160 is coupled into the fixing cap 140 in a ring shape. In particular, the washer 160 contracts in the radial direction based on the fastening of the fixing cap 140, and the shape contracted in the radial direction is restored to an original shape when the fastening of the fixing cap 140 is released. To this end, the washer 160 includes the first annular body 161 that is located at the front relative to the fastening direction of the fixing cap 140 and is contracted and restored in the radial direction, and the second annular body 163 connected to the rear end of the first annular body 161. The second annular body 163 has a relatively reduced diameter compared to that of the first annular body 161.

The first annular body 161 includes the plurality of gaps 1612 cut in the straight line shape at the set spacing along the circumferential direction. The plurality of gaps 1612 enable the contraction and the restoration in the radial direction of the first annular body 161. That is, the first annular body 161 may be contracted or restored in the radial direction by contraction and expansion of the plurality of gaps 1612.

The wedge-shaped protrusion 1611 is further disposed on the outer circumferential surface of the first annular body 161.

The wedge-shaped protrusion 1611 refers to a wedge-shaped portion that protrudes obliquely downward from the outer circumferential surface of the first annular body 161 toward the fixing cap 140.

When the fixing cap 140 is fastened to the main body 110, the wedge-shaped protrusion 1611 faces an insertion guide surface 118 of an extension body 113 protruding from the main body 110 and is pressed in the radial direction. Accordingly, when the fixing cap 140 is fastened, the washer 160 may be contracted such that the first annular body 161 is retracted toward the pipe 10.

The coupling member 180 includes the plurality of toothed protrusions 183 protruding in the radial direction from the inner circumferential surface of the washer 160 toward the outer circumferential surface of the pipe 10.

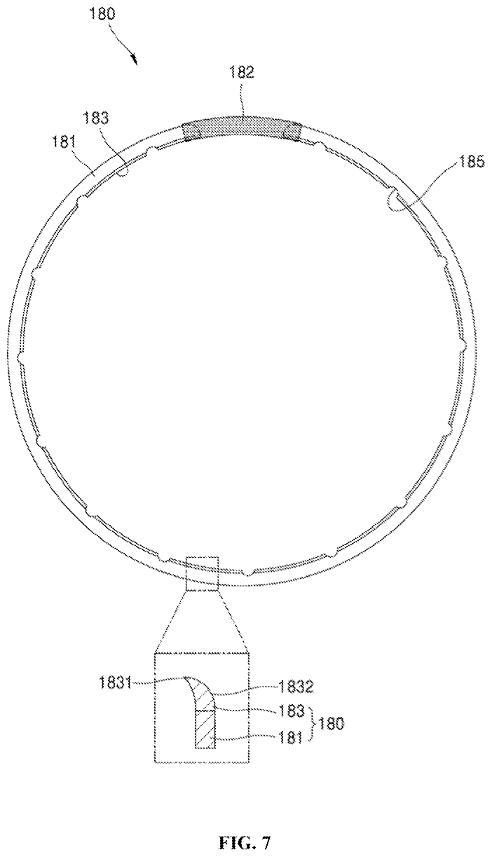

In one embodiment of the present disclosure, the coupling member 180 includes the ring-shaped body 181, the plurality of toothed protrusions 183, and an elastic connection member 182 (see FIG. 7).

Referring to FIG. 7, the ring-shaped body 181 refers to a ring-shaped metal member inserted into the inner circumferential surface of the washer 160 (see FIG. 6). The ring-shaped body 181 may be made of a flexible metal material that may be bent by an external pressure.

Because the ring-shaped body 181 is inserted into the inner circumferential surface of the washer 160 (see FIG. 6) that contracts in the radial direction when the fixing cap 140 is fastened thereto, in response to the contraction of the washer 160 (see FIG. 6), the ring-shaped body 181 may be contracted in the radial direction together with the washer 160 (see FIG. 6).

Respective ends on one side of the plurality of toothed protrusions 183 are connected to each other in the circumferential direction at a predetermined spacing inside the ring-shaped body 181. Respective ends on the other side of the plurality of toothed protrusions 183 protrude in the sawtooth shape in the radial direction of the ring-shaped body 181.

In this regard, a plurality of spacing grooves 185 defined so as to be spaced apart from each other at a predetermined distance are defined between the plurality of toothed protrusions 183.

For example, each of the plurality of spacing grooves 185 may have a shape of a circular groove (or a semi-circular groove or an arc-shaped groove).

When the plurality of spacing grooves 185 have a circular groove shape with a constant radius of curvature, a great load being concentrated on a specific portion of the spacing grooves 185 may be prevented when the ring-shaped body 181 contracts in response to the contraction of the washer 160 (FIG. 6). As such, as one circular groove-shaped spacing groove 185 is defined between each two of the plurality of toothed protrusions 183, a load applied to the coupling member 180 when the coupling member 180 is contracted or expanded (restored) may be evenly distributed. As a result, local damage or deformation of the coupling member 180 made of metal may be prevented. In addition, improvement of durability against the contraction and the restoration of the coupling member 180 may be expected.

In one example, the ring-shaped body 181 may be inserted into a circular fitting groove 162 defined in the inner circumferential surface of the washer 160. Therefore, it is not necessary to insert and assemble the plurality of toothed protrusions 183 in the form of separate pieces into the washer 160 one by one. Further, the ring-shaped body 181 may perform the act of being contracted or restored along with the washer 160 in the radial direction in response to the contraction and the restoration of the washer 160. Accordingly, the plurality of toothed protrusions 183 connected into the ring-shaped body 181 may pressurize the outer circumferential surface of the pipe 10 or release the pressurization, and may fix or release the pipe.

The elastic connection member 182 serves to provide an elastic force necessary for restoration of the ring-shaped body 181.

An elastic band-shaped member having both ends connected to an opening in which a partial circular arc section is disconnected of the ring-shaped body 181 may be used for the elastic connection member 182. For example, unlike the ring-shaped body 181 made of the metal material, the elastic connection member 182 may be made of a material that is more elastic, flexible, does not easily break, is stretched as much as needed, or is able to be restored to an initial shape thereof when the external force is released after being stretched. For example, the elastic connection member 182 may be made of a material such as rubber.

In one embodiment of the present disclosure, when the fixing cap assembly 130 is coupled to the main body 110 in the rotating manner, as the washer 160 contracts, the ring-shaped body 181 contracts in the radial direction. As the ring-shaped body 181 contracts in the radial direction, both ends of the elastic connection member 182 are compressed and thus the elastic connection member 182 contracts.

Conversely, when the fixing cap assembly 130, which has been coupled to the main body 110 in the rotating manner, is separated from the main body 110, the washer 160 expands. When the washer 160 expands, the elastic force of the elastic connection member 182 is transmitted to a connection portion between the ring-shaped body 181 and the elastic connection member 182. With such elastic force, the contracted ring-shaped body 181 expands. As the ring-shaped body 181 expands, the toothed protrusions 183 do not pressurize the outer circumferential surface of the pipe 10, so that the pipe 10 may be easily separated from the main body 110.

In one example, the toothed protrusion 183 may have a sharp portion 1831 whose cross-section is reduced in a direction of protrusion away from the ring-shaped body 181. The sharp portion 1831 refers to a tip of the sawtooth shape that may be sharply meshed with and fix the outer circumferential surface of the pipe.

In this regard, one surface of the sharp portion 1831 may be formed to have a curved surface 1832 bent in a direction opposite to a direction W1 (see FIG. 5) of connection of the pipe.

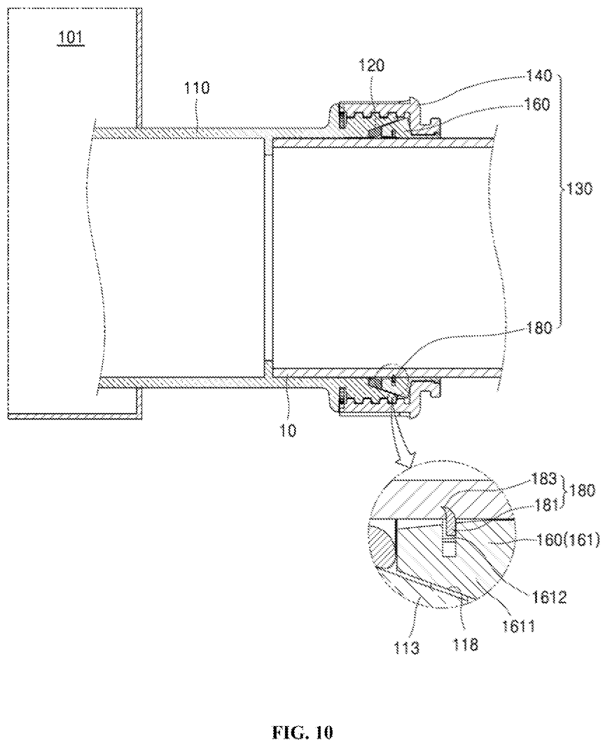

When one surface of the sharp portion 1831 has the curved surface 1832 bent in a round shape, and such curved surface 1832 is formed in the direction opposite to the direction W1 (see FIG. 5) of connection of the pipe, friction or interference between the pipe and the sharp portion 1831 when the pipe 10 (see FIG. 10) is inserted may be reduced. This makes it easy to insert the pipe 10 and reduces damage to a surface of the pipe 10.

In addition, after the connection between the sharp portion 1831 and the pipe is made, the sharp portion 1831 may be directed in a direction opposite to a direction in which the pipe 10 is separated, thereby preventing the separation and the disengagement of the pipe 10 and coupling the pipe 10 with a greater strength.

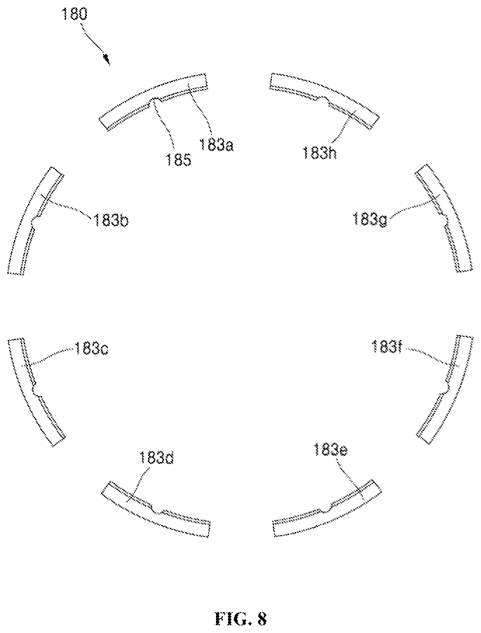

In another embodiment of the present disclosure, the coupling member 180 may include only some 183a to 183h of the plurality of toothed protrusions that are directly inserted into and fixed to the inner circumferential surface of the washer 160 (see FIG. 8). In this case, the plurality of toothed protrusions 183a to 183h are provided in the form of multiple pieces separated from each other.

Each of the toothed protrusions 183a to 183h may be made of a flexible metal material that may be bent by the external pressure.

In addition, the circular or semicircular spacing grooves 185 are defined in the respective toothed protrusions 183a to 183h. The load applied to the coupling member 180 when the coupling member 180 is contracted or expanded (restored) may be evenly distributed by the spacing grooves 185 defined in the respective toothed protrusions 183a to 183h. As a result, the local damage or deformation of the coupling member 180 made of the metal material may be prevented. In addition, the improvement of the durability against the contraction and the restoration of the coupling member 180 may be expected.

Although FIG. 8 shows the embodiment in which the coupling member 180 includes the eight tooth-shaped protrusions 183a to 183h, the number of tooth-shaped protrusions included in the coupling member 180 may vary according to the embodiment. Each of the toothed protrusions 183a to 183h may be inserted into and fixed to the inner circumferential surface of the washer 160 and protrude in the sawtooth shape.

FIG. 9 is a cross-sectional view showing a state before connecting a pipe to a main body using a fixing cap assembly according to an embodiment of the present disclosure, and FIG. 10 is a cross-sectional view showing a state after connecting a pipe to a main body using a fixing cap assembly.

First, the fixing cap assembly 130 is partially fastened to the main body 110 (see FIG. 9). Subsequently, the pipe 10 is inserted into the main body 110, and the fastening of the fixing cap assembly 130 is completed (see FIG. 10).

Referring to FIG. 9, before inserting the pipe 10, the sealing member 120 is inserted into the main body 110. When the fixing cap 140 is fastened, the washer 160 is introduced into the main body 110 in the fastening direction of the fixing cap 140 together with the fixing cap 140, and pressurizes the sealing member 120.

The sealing member 120 includes an elastic ring 121 and an elastic band 123. The elastic ring 121 is accommodated in the sealing member receiving portion 117, and is pressed by the tip of the washer 160 when the fixing cap 140 is fastened. The elastic band 123 may protrude from the elastic ring 121 in a band shape, and the elastic ring 121 may be deformed to increase a contact area by the pressurization of the washer 160. Accordingly, the watertightness may be secured even under the high water pressure condition.

Referring to FIG. 10, after the pipe 10 is completely inserted into the main body 110, the fastening of the fixing cap 140 is completed.

The main body 110 refers to at least a portion of an apparatus 101 such as the various equipment to which the pipe 10 is connected, for example, the house inlet and the small manhole. The pipe 10 is connected to and fixed to the main body 110.

While the fixing cap 140 is completely fastened, the first annular body 161 of the washer 160 comes into close contact with the insertion guide surface 118 and contracts in the radial direction. Accordingly, the coupling member 180 fixed to the fitting groove 162 of the first annular body 161 contracts in the radial direction, and the toothed protrusion 183 is strongly meshed with the outer circumferential surface of the pipe 10 to maintain the connection state of the pipe 10.

The insertion guide surface 118 of the main body 110 serves to contract the washer 160 and the coupling member 180 in the radial direction based on a degree of fastening of the fixing cap 140, and as a result, allows the toothed protrusions 183 to pressurize the outer circumferential of the pipe 10.

Pipe Fitting

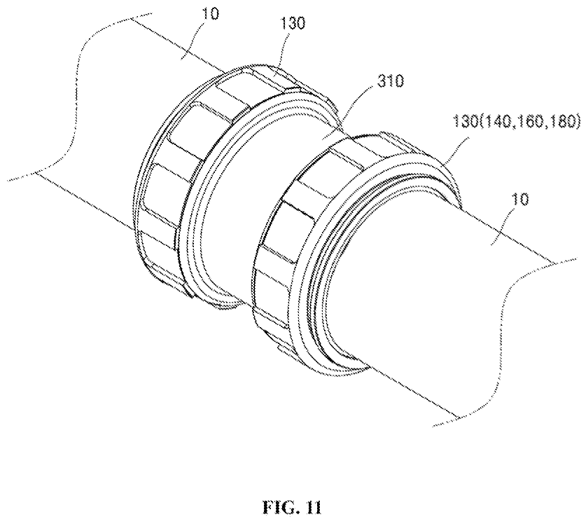

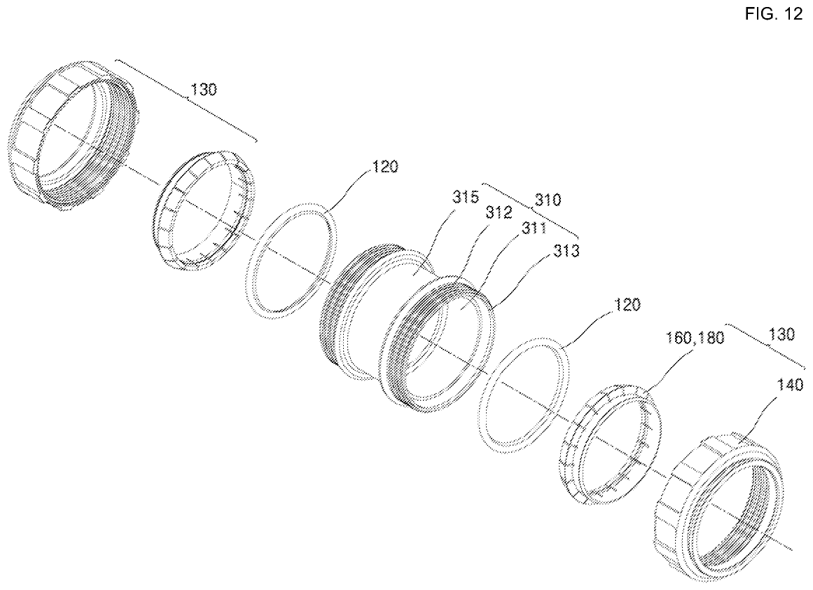

FIGS. 11 and 12 are perspective views showing a pipe fitting connection structure including a fixing cap assembly according to an embodiment of the present disclosure.

A pipe fitting according to an embodiment of the present disclosure includes a pipe fitting main body 310, the plurality of sealing members 120, and the plurality of fixing cap assemblies 130.

The pipe fitting main body 310 connects the plurality of pipes 10 to both ends thereof to extend or change the flow direction. The pipe fitting main body 310 may not be necessarily limited to have the shown shape, and have various shapes such as a ‘¬’ shape, a ‘Y’ shape, and the like.

The pipe fitting main body 310 includes a pipe receiving portion 311 in which the pipe is received, and a male thread 312 screwed with the female thread 144 formed on the inner circumferential surface of the fixing cap 140. In addition, at an outer end of the male thread 112, the extension body 113 extending by a predetermined length and protruding in a length direction of the pipe fitting main body 310 is formed.

In addition, the pipe fitting main body 310 includes a connection portion 315, which is a tubular body connecting the plurality of pipe receiving portions 311 to each other. The connection portion 315 has a tubular shape with a diameter reduced than that of the plurality of pipe receiving portions 311. A length of the connection portion 315 may not be necessarily limited to that in the drawing, and may be greater or smaller than that in the drawing. The connection portion 315 may have various shapes, such as a ‘¬’ shape or a ‘Y’ shape, according to the embodiment.

The plurality of sealing members 120 are inserted into both ends of the pipe fitting main body 310, and create a seal between both ends of the pipe fitting main body 310 and the plurality of pipes 10.

In addition, the pipe fitting according to the embodiment of the present disclosure includes the plurality of fixing cap assemblies 130 for connecting and fixing the pipe fitting main body 310 and the plurality of pipes 10 to each other. The fixing cap assembly 130 includes the fixing cap 140, the washer 160, and the coupling member 180.

Here, a description of the fixing cap assembly 130 will be omitted because it is redundant with the description that has been made with reference to FIGS. 1 to 10.

As described above, according to the embodiments of the present disclosure, as the pipes are connected to each other with the great coupling force, there is the advantages of securing the watertightness and preventing the disengagement of the pipes even under the high water pressure condition.

In addition, according to the embodiments of the present disclosure, because the pipes are connected to each other with the great coupling force, the watertightness may be secured and the disengagement of the pipes may be prevented even under the high water pressure condition.

In addition, according to the embodiments of the present disclosure, the fitting groove may be defined in the inner circumferential surface of the washer, and the coupling member for the connection of the pipe may be formed in the scheme of directly assembling the plurality of toothed protrusions formed in the shape of the separated pieces to the fitting groove or coupling the plurality of toothed protrusions in an integrated manner to the ring-shaped body that is inserted into the fitting groove. Accordingly, according to the present disclosure, even with the relatively simple structure, the washer and the coupling member are not exposed to the outside of the fixing cap, so that an outer appearance may be excellent. Further, because the washer may contract and the coupling member may strongly pressurize the outer circumferential surface of the pipe by simple fastening of the fixing cap, a strength of the pipe connection may be improved.

As described above, the present disclosure has been described with reference to the drawings, but the present disclosure is not limited by the embodiments and drawings disclosed herein, and it is obvious that various modifications may be made by a person skilled in the art within the scope of the technical idea of the present disclosure. In addition, although operational effects of the components of the present disclosure have not been explicitly described while describing the embodiment of the present disclosure, it is natural that effects predictable by the corresponding components should also be acknowledged.

What is claimed is:

1. A fixing cap assembly comprising:
a fixing cap fastened to a connection portion of a main body to be connected with at least one pipe, wherein the fixing cap fixes the main body and the pipe to each other;
a washer located inside the fixing cap, wherein the washer compresses a sealing member interposed between the main body and the pipe as the fixing cap is fastened to the connection portion, wherein the washer is contracted and restored in a radial direction; and
a coupling member including a plurality of toothed protrusions, wherein the plurality of toothed protrusions protrude in the radial direction from an inner circumferential surface of the washer toward an outer circumferential surface of the pipe, wherein the plurality of toothed protrusions fix the pipe by pressurizing the outer circumferential surface of the pipe as the washer is contracted.

2. The fixing cap assembly of claim 1, wherein the coupling member further includes a ring-shaped body inserted into the inner circumferential surface of the washer and contracted and restored in the radial direction based on the washer,
wherein respective ends on one side of the plurality of toothed protrusions are connected to each other in a circumferential direction with predetermined spacing grooves therebetween inside the ring-shaped body, and respective ends on the other side of the plurality of toothed protrusions protrude in a sawtooth shape toward the outer circumferential surface of the pipe.

3. The fixing cap assembly of claim 2, wherein the plurality of spacing grooves are defined between the plurality of toothed protrusions so as to be spaced apart from each other at a certain distance.

4. The fixing cap assembly of claim 3, wherein each of the plurality of spacing grooves has a circular groove shape.

5. The fixing cap assembly of claim 2, wherein the ring-shaped body is inserted into a circular fitting groove defined in the inner circumferential surface of the washer.

6. The fixing cap assembly of claim 5, wherein the coupling member further includes an elastic connection member for providing an elastic force required for the restoration when the ring-shaped body contracts,
wherein both ends of the elastic connection member are connected to an opening where a partial circular arc section is disconnected in a ring shape of the ring-shaped body, wherein the elastic connection member is made of an elastic material.

7. The fixing cap assembly of claim 1, wherein each toothed protrusion has a sharp portion whose cross-section is reduced in a direction of protrusion thereof away from the ring-shaped body,
wherein one surface of the sharp portion is formed to have a curved surface bent in a direction opposite to a connection direction of the pipe.

8. The fixing cap assembly of claim 1, wherein the plurality of toothed protrusions are provided in a form of multiple pieces separated from each other.

9. The fixing cap assembly of claim 1, wherein the washer includes:
a first annular body located at a front relative to a fastening direction of the fixing cap, wherein the first annular body is contracted and restored in the radial direction, wherein the first annular body has a circular fitting groove defined therein; and
a second annular body connected to a rear end of the first annular body relative to the fastening direction of the fixing cap, wherein the second annular body has a reduced diameter compared to a diameter of the first annular body,
wherein the first annular body includes a plurality of gaps cut in a straight line shape at a predetermined spacing along a circumferential direction,
wherein a wedge-shaped protrusion protruding obliquely downward toward the fixing cap is further disposed on an outer circumferential surface of the first annular body.

10. The fixing cap assembly of claim 1, wherein the fixing cap includes an annular cap body having a hollow for receiving the pipe inserted thereinto,
wherein the cap body has an inner diameter greater than an outer diameter of the pipe to be connected,
wherein a plurality of circumferential protrusions protruding so as to be spaced apart from each other in a circumferential direction are disposed on an outer circumferential surface of the cap body,
wherein a female thread screwed to a male thread of the main body is disposed on an inner circumferential surface of the cap body.

11. The fixing cap assembly of claim 1, wherein the main body includes:
a pipe receiving portion formed in the connection portion of the main body to be connected with the pipe, wherein at least a portion of the pipe is inserted into the pipe receiving portion;
a pipe support formed inside the pipe receiving portion and protruding to restrict an insertion length of the pipe;
a male thread formed on an exterior of the pipe receiving portion and screwed to a female thread of the fixing cap; and
a sealing member receiving portion formed stepwise inside the pipe receiving portion and accommodating the sealing member therein.

12. The fixing cap assembly of claim 11, wherein the washer is formed such that a tip thereof enters the sealing member receiving portion when the fixing cap is fastened,
wherein the sealing member includes at least one elastic ring elastically deformed such that a contact area between the main body and the pipe is expanded by pressurization of the tip of the washer in the sealing member receiving portion when the fixing cap is fastened.

13. A pipe fitting comprising:
a pipe fitting main body for connecting a plurality of pipes to each other;
each sealing member inserted into each of both ends of the pipe fitting main body, wherein each sealing member creates a sealing between each end of the pipe fitting main body and each pipe;
each fixing cap screwed to each end of the pipe fitting main body while surrounding a connection portion of each pipe;
each washer located inside each fixing cap, wherein the washer compresses each sealing member located between the pipe fitting main body and each pipe as the fixing cap is fastened, wherein the washer is contracted and restored in a radial direction; and
each coupling member including a plurality of toothed protrusions, wherein the plurality of toothed protrusions protrude in the radial direction from an inner circumferential surface of each washer toward an outer circumferential surface of each pipe, wherein the plurality of toothed protrusions pressurize and fix the outer circumferential surface of the pipe as the washer is contracted.
